(19) United States
(12) Patent Application Publication
(10) Pub. No.: US 2007/0026170 A1
(43) Pub. Date: Feb. 1, 2007

(54) Recording medium

(75) Inventors: Kenichi Kawano, Fukui-shi (JP); Tadashi Fujii, Yokohama-shi (JP); Tatsuo Hiyoshi, Tokyo (JP)

Correspondence Address: FITZPATRICK CELLA HARPER & SCINTO, 30 ROCKEFELLER PLAZA, NEW YORK, NY, 10112, US

(73) Assignee: Canon Finetech Inc., Mitsukaido-shi (JP)

(21) Appl. No.: 11/489,621

(22) Filed: Jul. 20, 2006

(30) Foreign Application Priority Data
Jul. 26, 2005 (JP) 2005-216533 (PAT.
Jun. 16, 2006 (JP) 2006-167645 (PAT.

(51) Int. Cl. B41M 5/40

(52) U.S. Cl. 428/32.34

(57) ABSTRACT

A recording medium has an ink-receiving layer provided on at least one surface of a substrate, wherein the substrate comprises a base material, and a resin layer having ink absorbency and/or ink permeability formed at least on the side of the base material on which the ink-receiving layer is provided, and wherein the resin layer has a contact angle with respect to water of 60° or smaller, a water vapor transmission rate of 100 g/m²/24 hr or larger according to JIS-Z-0208 and the thickness of 10 to 100 μm.

### BACKGROUND OF THE INVENTION

1. Field of the Invention

The present invention relates to a recording medium which enables recording of an image with high glossiness and high quality superior in image density and ink absorbency, and effectively prevents the image from bleeding under high-temperature and high-humidity environment.

2. Description of the Related Art

With an ink jet recording system, droplets of ink are generated and caused to fly by using various ink ejection systems such as an electrostatic attraction system, a system of applying mechanical vibration or displacement to the ink with the use of an piezoelectric element and a system of heating and bubbling the ink to utilize the pressure, and then the ink droplets are applied onto a recording medium such as paper or a plastic film having an ink-receiving layer formed thereon to conduct recording. The printing system makes little noise and can make a multicolor printing at a high speed, so that it has become rapidly widespread in recent years.

As an ink jet recording device using such an ink jet recording system improves its performances such as speeding-up of recording operation and recording with higher resolution, advanced characteristics are required to a recording medium. Such characteristics include:

(1) having excellent adhesiveness between an ink-receiving layer and a substrate;

(2) causing little change in the characteristics caused by the change of temperature and humidity, and no curling;

(3) causing no blocking;

(4) producing a high optical density of printed dots as well as a vivid and bright color tone;

(5) producing a printed image with high chroma (no somberness);

(6) providing dots with an approximately perfectly circular shape with its perimeter being smooth;

(7) having high ink-absorption capacity (a high absorption rate and a large absorption capacity);

(8) having excellent water resistance in the ink-receiving layer and a printed part of the printed image;

(9) imparting excellent light resistance to the printed part of the printed image; and

(10) keeping the printed image stable and causing no change in the image under high-temperature and high-humidity environment.

In addition, a transparent recording medium such as OHP is required to have transparency not only of a film of a substrate but also of an ink-receiving layer. Similarly, a white substrate such as a white film and a resin-coated paper coated with a resin such as polyethylene on both faces of the base paper is required to have an ink-receiving layer superior in transparency so as not to impair the whiteness and glossiness of the substrate in itself. Furthermore, a glossy paper for providing a photo-like high-resolution recorded article is required to show glossiness, surface smoothness and texture similar to photographic paper for a silver halide photograph.

However, these various characteristics often have a trade-off relationship, and it has been conventionally difficult to simultaneously satisfy them with a well-known technology. Particularly, a recording medium using resin-coated paper as a substrate, which is predominant from the viewpoint of glossiness and texture, has had such a problem that when it has an image recorded with an ink containing a water-soluble dye as a coloring material and is preserved under high-temperature and high-humidity environment for a long period of time, the dye bleeds and the image quality deteriorates.

As a method for solving such a problem, many methods have been previously proposed. For instance, Japanese Patent Application Laid-Open No. S59-198186 and Japanese Patent Application Laid-Open No. S59-198188 propose a method of incorporating polyethyleneimine in a base material or a coating layer on a base material; Japanese Patent Application Laid-Open No. S61-61887, Japanese Patent Application Laid-Open No. S61-72581, Japanese Patent Application Laid-Open No. S61-252189 and Japanese Patent Application Laid-Open No. S62-174184 propose a method of using polyallylamine as a mordant; Japanese Patent Application Laid-Open No. S63-307979 proposes a method of providing a layer which contains a mordant of a hydrophilic polymer having tertiary or quaternary nitrogen atoms and a polymer containing a vinyl monomer unit containing a hydrophilic group; Japanese Patent Application Laid-Open No. S63-162275 proposes a method of applying or impregnating a cationic polymer and a cationic surface active agent onto or into a substrate; Japanese Patent Application Laid-Open No. H06-143798 proposes a method of providing a dye-fixing layer mainly containing a polymer of a quaternary ammonium salt and a cation-modified polyvinyl alcohol; and Japanese Patent Application Laid-Open No. H08-142496 provides a method of employing particular two cationic polymers together. In addition; a method of adding a polymer or compound containing a particular tertiary or quaternary nitrogen atom into an ink-receiving layer is described in Japanese Patent Application Laid-Open No. S59-20696, Japanese Patent Application Laid-Open No. S59-33176, Japanese Patent Application Laid-Open No. S59-33177, Japanese Patent Application Laid-Open No. S59-96987, Japanese Patent Application Laid-Open No. S59-155088, Japanese Patent Application Laid-Open No. S60-11389, Japanese Patent Application Laid-Open No. S60-49990, Japanese Patent Application Laid-Open No. S60-83882, Japanese Patent Application Laid-Open No. S60-109894, Japanese Patent Application Laid-Open No. S61-277484, Japanese Patent Application Laid-Open No. S61-293886, Japanese Patent Application Laid-Open No. S62-19483, Japanese Patent Application Laid-Open No. S62-198493, Japanese Patent Application Laid-Open No. S63-49478, Japanese Patent Application Laid-Open No. S63-115780, Japanese Patent Application Laid-Open No. S63-203896, Japanese Patent Application Laid-Open No. S63-274583, Japanese Patent Application Laid-Open No. S63-280681, Japanese Patent Application Laid-Open No. S63-260477, Japanese Patent Application Laid-Open No. H01-9776, Japanese Patent Application Laid-Open No. H01-24784, Japanese Patent Application Laid-Open No. H01-40371, Japanese Patent Application Laid-Open No. H03-133686, Japanese Patent Application Laid-Open No. H06-234268, Japanese Patent Application Laid-Open No. H07-125411, Japanese Patent Application Laid-Open No. H08-318672 and Japanese Patent Application Laid-Open No. H10-029369.

Any of the above described methods is a technology for preventing the bleeding of an image under high-temperature and high-humidity environment by combining an anionic dye with a cationic polymer to insolubilize the dye in water, but needs a large quantity of the cationic polymer in order to obtain a sufficient effect, which results in relatively increasing the amount of the cationic polymer in an ink-receiving layer. Thus, the increased amount of the cationic polymer causes a problem of decreasing voids in a porous (void type) ink-receiving layer containing inorganic fine particles and degrading ink absorbency. In addition, most cationic polymers have a tendency to increase the viscosity of a coating slip for forming the ink-receiving layer containing inorganic fine particles, though depending on molecular weight and cationized degree of the cationic polymer. As the amount of added cationic polymers increases, the above tendency also increases and the coating stability of the coating slip is remarkably degraded. As a result, the increased amount of the cationic polymer has caused the problem of aggravating the smoothness of the ink-receiving layer on the surface of a coated film and decreasing the glossiness of a formed image.

On the other hand, among recording media classified as glossy paper, there is a recording medium having an ink-receiving layer formed on a substrate having water absorbency such as paper and coat paper with a cast method. Such a type of a recording medium has an advantage of having excellent ink absorbency and hardly causing bleeding of an image under high-temperature and high-humidity environment in comparison with the recording medium using a film and a resin-coated paper as a substrate. However, the recording medium having the ink-receiving layer placed on the water-absorptive substrate has a problem of having difficulty in controlling curling, degrading glossiness in a printing part, and causing cockling in the recording medium when a large quantity of ink was shot in. Furthermore, the recording medium produced by the cast method has its ink-receiving layer smoothed by contacting the layer in a wet state with a heated mirror-surface roll in the production process, but the process was less advantageous from the viewpoint of cost than a recording medium based on a film or a resin-coated paper requiring no such smoothing treatment, because of a decreased speed and a lower productivity in producing the recording medium.

Further features of the present invention will become apparent from the following description of exemplary embodiments.

### SUMMARY OF THE INVENTION

The present invention is designed in the light of the above described circumstances and is directed to a recording medium which enables recording of an image with high glossiness and high quality superior in image density and ink absorbency, and effectively prevents the image from bleeding out under high-temperature and high-humidity environment.

As a result of extensive research for obtaining a recording medium which has an ink-receiving layer formed thereon superior in glossiness without smoothing treatment, has excellent image density and ink absorbency, and hardly causes bleeding on an image under high-temperature and high-humidity environment, the present inventors found that a plurality of the above described problems are simultaneously solved by providing a resin layer having ink absorbency and/or ink permeability on a base material and by controlling the contact angle with respect to water, the water vapor transmission rate according to JIS-Z-0208 and the thickness of the resin layer into a particular range, and accomplished the present invention.

Specifically, the present invention provides a recording medium having an ink-receiving layer provided on at least one surface of a substrate, wherein the substrate comprises a base material, and a resin layer having ink absorbency and/or ink permeability formed at least on the side of the base material on which the ink-receiving layer is provided; and the resin layer formed on the base material has such a contact angle with respect to water, a water vapor transmission rate according to JIS-Z-0208 and a thickness as to satisfy the following relationships (1) to (3).
contact angle of resin layer≦60° (1)
water vapor transmission rate of resin layer≧100 g/m²/24 hr (2)
10 μm≦thickness of resin layer≦100 μm (3)

It is preferable for the above-described recording medium according to the present invention that a resin layer mainly includes at least one resin selected from the group consisting of cellulose and a derivative thereof; a vinyl polymer such as polyvinyl alcohol and ethylene-vinyl alcohol copolymer; an acrylic polymer such as polyacrylonitrile and (meth)acrylates; and a polysulfone polymer, and that an ink-receiving layer includes inorganic fine particles, and a water-soluble resin and/or a water-dispersible resin.

The above described constitution according to the present invention can provide a recording medium that has an ink-receiving layer on which a high-gloss image is formed without needing smoothing treatment, can conduct high-quality image recording superior in image density and ink absorbency recorded thereon, and effectively prevents an image from bleeding under high-temperature and high-humidity environment.

### DETAILED DESCRIPTION OF THE PREFERRED EMBODIMENTS

The present invention will be described in more detail with reference to the best mode for carrying out the invention.

A base material to be used in the present invention is not limited in particular but includes, for instance, a material made of paper such as adequately-sized paper, unsized paper, coat paper, cast-coated paper and a resin-coated paper of which one or both surfaces are coated with a resin such as polyolefin (hereafter referred to as “resin-coated paper”); a transparent thermoplastic resin film such as polyethylene, polypropylene, polyester, polylactic acid, polystyrene, polyacetate, polyvinyl chloride, cellulose acetate, polyethylene terephthalate, polymethyl methacrylate and polycarbonate; a sheet material (synthetic paper or the like) composed of a film opacified by filling it with an inorganic substance or by fine voids; a cloth; and besides, a sheet composed of glass or metal.

When the base material in itself needs to have a high liquid-absorbency (absorbency particularly for an aqueous ink or a water-soluble solvent in the aqueous ink) from the viewpoint of ink absorbency, paper or cloth can be preferably used among the above described base materials. Here, the water-soluble solvent means water, or a mixture of water and an organic solvent miscible with water. The organic solvent miscible with water includes, for instance, an alcohol such as methanol, ethanol and propanol; a lower alkyl ether of a polyhydric alcohol such as ethyleneglycol, diethylene glycol, ethyleneglycolmonomethyl ether and ethyleneglycoldimethyl ether; a ketone such as acetone and methylethylketone; and an ether such as tetrahydrofuran.

A substrate according to the present invention is obtained by forming a resin layer on the above described base material. When producing a recording medium capable of imparting image quality equal to that of a silver halide photograph by improving the smoothness of the surface of the resin layer and further improving the glossiness of an ink-receiving layer formed on the resin layer, it is preferable to employ a highly smooth base material such as woodfree paper, coat paper, art paper and cast-coated paper, among the above described base materials with liquid-absorbency. Particularly, a base material preferably has a Bekk smoothness of 10 seconds or longer defined by JIS-P-8119, more preferably 50 seconds or longer, and still more preferably 100 seconds or longer.

The thickness of a base material is not limited in particular, but is preferably in a range of 25 to 500 μm, and more preferably is in a range of 50 to 300 μm. When the base material is thinner than 25 μm, an obtained recording medium haves low rigidity and produces inconvenience such as causing insufficient touch and texture when touched with hands and causing insufficient opacity. On the contrary, when the base material is thicker than 500 μm, an obtained recording medium becomes rigid and may interfere with the feeding and traveling of paper in a printer. The weight of the base material is not limited either in particular, but is preferably in a range of about 25 to 500 g/m².

The substrate according to the present invention is obtained by forming a resin layer having ink absorbency and/or ink permeability (which means absorbency or permeability for aqueous ink or a water-soluble solvent in the aqueous ink in particular, and hereafter is referred to as just “ink permeability” unless otherwise indicated), on at least one surface of the above described base material.

It is preferable that a resin layer formed on a base material is comprised mainly of a hydrophilic polymer which has high wettability to aqueous ink and can make aqueous ink (particularly, water-soluble solvent in ink) be absorbed therein or permeate therethrough. The hydrophilic polymer includes, for instance, cellulose; a cellulose derivative (such as a cellulose ester (a cellulose acetate such as cellulose diacetate and cellulose triacetate), an organic ester like cellulose propionate, cellulose butyrate, cellulose acetate propionate, cellulose acetate butyrate and cellulose acetate phthalate, an inorganic ester like cellulose nitrate, cellulose sulfate and cellulose phosphate, and a mixed acid ester like cellulose nitrate acetate), and a cellulose ether (ethyl cellulose)); a vinyl polymer (such as polyvinyl acetate and a completely or partially saponificated substance thereof (polyvinyl alcohol or the like), and an ethylene-vinylacetate copolymer and a completely or partially saponificated compound thereof (ethylene-vinylalcohol copolymer)); an acrylic polymer (such as polyacrylonitrile, poly(meth) acrylate, polyacrylamide and poly N-methylacrylamide); polyvinylpyrrolidone; polyalkylene oxide (polyethylene glycol and the like); a polyalkylvinyl ether (polymethylvinyl ether and the like); a carboxyl-group-containing polymer or a salt thereof (styrene-maleicanhydride copolymer), (meth)alkylacrylate ester-(meth)acrylic acid copolymer, methylvinylether-maleic anhydride copolymer and the like), a polysulfone polymer (polysulfone, polyethersulfone and the like); polyamide; and polyethyleneimine. These hydrophilic polymers can be used singly or in combination of two or more of them.

Among the above described polymers can be preferably used cellulose and a derivative thereof; an acrylic polymer such as polyacrylonitrile and (meth)acrylates; and a polysulfone polymer, which are used as a material of a so-called semi-permeable membrane; and a vinyl polymer such as polyvinyl alcohol and ethylene-vinyl alcohol copolymer, since all those polymers are particularly excellent in showing the effect of inhibiting an image from bleeding under high-temperature and high-humidity environment which characterizes the substrate according to the present invention.

The resin layer mainly containing the above described hydrophilic polymer should have a contact angle of less than 80° with respect to water, but the resin layer according to the present invention has a contact angle of 60° or less, and preferably of 40° or less, from the viewpoint of improving the ink permeability of the resin layer. The contact angle in the above description means an angle formed between a tangent line of a droplet of water and a polymer surface at the point of intersection of the resin layer with the surface of the a droplet of water put on the surface of the resin layer; and accordingly the smaller the angle is, the higher the wettability of the resin layer to aqueous ink is. The value of the contact angle in the present invention is obtained by the steps of leaving a film composed of the above described hydrophilic polymer in an environment of 23° C. and 50% RH for 12 hours; dropping 2 μl of pure water onto the film; leaving the droplet until it spreads to the maximum radius (after a lapse of 0.1 to 60 seconds after drop) in such a range that a fluid volume does not change (in such a range that the droplet is not absorbed by the film and does not vaporize); and when it reached this point, measuring the angle with the use of a contact angle measurement device. An automatic contact angle meter CA-VP (made by Kyowa Interface Science Co., Ltd.) was used for measuring the contact angle in the present invention.

In addition, the resin layer according to the present invention has a water vapor transmission rate of 100 g/m²/24 hr or more when measured according to JIS-Z-0208 and preferably of 300 g/m²/24 hr or more, in order to sufficiently make a recording medium show the effect specific to the present invention of acquiring an improved ink permeability of the resin layer and inhibiting an image from bleeding under high-temperature and high-humidity environment. In the above description, the water vapor transmission rate in the present invention is a value measured at a temperature-humidity condition (temperature: 40° C. and humidity: 90% RH) which is prescribed in JIS-Z-0208.

A substrate to be used in the present invention has a resin layer formed on a base material with a thickness of 10 to 100 μm and preferably of 10 to 50 μm. When having the thickness below 10 μm, the resin layer may have nonuniform ink absorbency because of formation of a defect such as a pinhole or may have the degraded smoothness of the surface of the resin layer because unevenness on the surface of a base material is not flattened, while the substrate is produced. On the contrary, when having a thickness over 100 μm, the resin layer may have low ink absorbency. Accordingly, the resin layer preferably has a thickness in the above described range and a surface roughness (maximum height (R_{y}) according to JIS-B-0601) higher than that of the base material, in order to make the surface thereof smoother and further to make the ink-receiving layer formed thereon more glossy.

The inventive method for forming a resin layer on a base material includes: a method of appropriately selecting a preferred hydrophilic polymer described above, dissolving or dispersing it in a suitable solvent, and applying it on the base material; a method of forming a film composed of the hydrophilic polymer, and laminating the film on the base material; and a method of laminating the film on the base material with an extrusion process. A coating slip having a hydrophilic polymer dissolved/dispersed therein may be applied by roll coating, blade coating, air knife coating, gate roll coating, bar coating, size press coating, a symsizer, spray coating, gravure coating, curtain coating or the like. An adhesive to be used in lamination includes an epoxy system, a polyurethane system, a polyester system, an isocyanate system, a phenolic system, a vinyl acetate system and an acrylic system.

When using cellulose as a hydrophilic polymer, it is acceptable to form a resin layer by applying/impregnating viscose on/into a base material and producing a regenerated cellulose film by the same method for producing viscose-processed paper, which is similar to a conventionally well-known method for producing a cellophane film.

The smoothness of the surface of a resin layer formed on a base material by the above described method is not limited in particular, but when the resin layer is used for producing such a recording medium as to provide photo-like picture quality by forming an ink-receiving layer on the resin layer, the surface of the resin layer preferably has a ten-point average roughness of 0.5 μm or less according to JIS-B-0601, and a 60-degree specular glossiness of 25% or higher prescribed by JIS-Z-8741.

When an ink-receiving layer is transparent and the color of a base material and the pattern of an uneven surface affect a printed image, though a resin layer may be transparent, semitransparent or opaque, it is acceptable to add various coloring agents, a white pigment and a fluorescent brightener into the resin layer in such a range as not to deteriorate the ink permeability of the resin layer. The resin layer may be formed into a multilayer consisting of layers each composed of a different type of a hydrophilic polymer and a different composition ratio of other additives; and can be formed on one or both surfaces of a base material. Particularly, a substrate having the resin layer formed on both surfaces is hardly charged with electricity even when an ink-receiving layer is formed on one surface thereof, because the resin layer in itself has a low surface electric resistance, thereby eliminating a need of such an antistatic treatment as is implemented on the rear surface of a general film and resin coat paper. The resin layer formed of a hydrophilic polymer also has an advantage of eliminating a need of such a treatment of converting the surface on which the ink-receiving layer is to be formed into an easily bondable surface as is implemented on a film having an hydrophobic surface or a resin-coated paper, because the resin layer has high affinity to an aqueous coating slip to be used when an ink-receiving layer is formed thereon. Both of the above advantageous points contribute to a cost reduction when producing a recording medium.

When a substrate has a resin layer formed only on one surface of a base material, it is acceptable to apply as a backcoat or laminate any of various resins other than the hydrophilic polymer to be used in the resin layer or alternatively a resin containing inorganic fine particles or an antistatic agent, on the rear surface having no resin layer formed thereon, for the purpose of adjusting water resistance, curl balance, coefficient of friction with the surface of an ink-receiving layer and electrostatic chargeability due to the friction or of preventing blocking of a recording medium, which occur when sheets of the recording medium derived from the substrate are stacked. It is also possible to treat the surface of the resin layer with electric corona discharge and form a various types of an undercoat, in order to increase the adhesive strength of the resin layer to the ink-receiving layer formed thereon.

According to the present invention, an ink-receiving layer containing a water-soluble resin and/or a water-dispersible resin as well as inorganic fine particles is formed on the resin layer of the substrate obtained as described above. The thus produced recording medium can conduct recording of an image of high quality superior in image density and ink absorbency recorded thereon, and can effectively prevent the image from bleeding under high-temperature and high-humidity environment.

Inorganic fine particles usable for forming an ink-receiving layer according to the present invention preferably has high ink-absorptivity, is superior in a color-developing property and can form a high-quality image. Such inorganic fine particles include, for instance, calcium carbonate, magnesium carbonate, kaolin, clay, talc, hydrotalcite, aluminum silicate, calcium silicate, magnesium silicate, diatomaceous earth, alumina, colloidal alumina, aluminum hydroxide, alumina hydrate, synthesized amorphous silica, colloidal silica, lithopone and zeolite. They can be singly used or some of them can be concomitantly used.

The above described inorganic fine particles preferably have an average particle size in a range of 50 to 500 nm and more preferably in a range of 100 to 300 nm, in order to obtain a highly glossy and highly transparent ink-receiving layer. When the inorganic fine particles have the average particle size of smaller than 50 nm, the ink-receiving layer remarkably lowers its ink absorbency, and causes bleeding and beading of ink (phenomenon of forming granular density irregularity because of being incapable of absorbing ink), when the recording medium is used for printing by a printer which ejects a large amount of ink.

On the other hand, when the inorganic fine particles have an average particle size of larger than 50 nm, the ink-receiving layer decreases its transparency and lowers the printing density and glossiness of an image. The average particle size according to the present invention is measured with a dynamic light-scattering method, and can be determined through analysis with the use of a cumulant method which is described in “Structure of Macromolecule (2), Scattering Experiment and Morphological Observation, Chapter 1, Light Scattering” (Kyoritsu Shuppan Co., edited by Society of Polymer Science, Japan) or in J. Chem. Phys., 70 (B), 15 Apl., 3965 (1979).

Preferably usable inorganic fine particles in the present invention among the above described inorganic fine particles includes silica, alumina and alumina hydrate, and alumina hydrate having a boehmite structure or a pseudoboehmite structure is more preferably usable, from the viewpoint of giving excellent transparency and smoothness to an ink-receiving layer to be formed, being capable of forming finer voids, and well fixing dyes in ink because of having the particle surface with a positive charge.

Particularly, the alumina hydrate preferably has a BET specific surface area of 50 m²/g or larger, more preferably in a range of 50 to 500 m²/g, and further preferably in a range of 50 to 250 m²/g. When the alumina hydrate has a BET specific surface area in a range of 50 to 500 m²/g, the ink-receiving layer haves superior ink absorbency and smoothness and does not cause beading. On the other hand, when the alumina hydrate has a BET specific surface area of smaller than 50 m²/g, the ink-receiving layer lowers its transparency, decreases the density of print formed thereon, and tends to produce a whitish and hazy image of a printed article. In addition, when the alumina hydrate has a BET specific surface area of larger than 500 m²/g the ink-receiving layer lowers its ink absorbency and a large quantity of an acid of a peptization agent is needed for stably dispersing the alumina hydrate, which are undesirable.

Alumina hydrate having a boehmite structure or a pseudoboehmite structure to be preferably used in the present invention is expressed by the following general formula (1).
Al₂0₃₋ₙ(OH)₂ₙ.mH₂0 (1)

In the above formula, n is any of integers of 0, 1, 2 and 3; and m represents a value of 0 to 10 and preferably 0 to 5, and can be another value than an integer because mH₂O mostly means a water phase which is not involved in the formation of a crystal lattice and can be desorbed. When this type of alumina hydrate is calcined, m can reach a value of 0.

The crystal of alumina hydrate showing a boehmite structure is generally a layered compound of which the (020) face forms a huge plane and shows a characteristic diffraction peak in an X-ray diffraction pattern. As for the boehmite structure, the alumina hydrate can have a structure in which excess water is contained between layers of the face (020), which is referred to as pseudoboehmite, in addition to a complete boehmite structure. The pseudoboehmite shows a wider diffraction peak than that of the complete boehmite in the X-ray diffraction pattern. Because the complete boehmite cannot be clearly distinguished from the pseudoboehmite, both alumina hydrates are hereafter referred to as alumina hydrate showing a boehmite structure unless otherwise indicated.

A method for producing the above described alumina hydrate is not limited in particular, but a usable method includes, for instance, a Bayer process and an alum thermal-decomposition method. A particularly preferred method is a method of adding an acid to a long-chain aluminum alkoxide and hydrolyzing the alkoxide. The particle shape of the resultant alumina hydrate can be controlled into a particular range by subjecting the alumina hydrate to a hydrothermal synthesis process and a subsequent aging process of growing the particle, while adjusting a condition of the aging process. Primary particles of the alumina hydrate with comparatively uniform particle sizes are grown by properly setting an aging period of time. The resultant sol can be directly used as a liquid dispersion after it is blended with an acid as a peptization agent, but can be converted into a liquid dispersion by powdering the sol by spray-dry or the like, and adding the acid to it, so as to improve the dispersibility of alumina hydrate into water. An acid for peptizing alumina hydrate can be a conventionally well-known acid for the use, and includes, for instance, an organic acid such as formic acid, acetic acid, propionic acid, butyric acid, glycolic acid, lactic acid, pyruvic acid and methanesulfonic acid, and an inorganic acid such as hydrochloric acid and nitric acid. One or more of them can be freely selected and be used as the acid.

A liquid dispersion can be prepared by using various surface active agents or macromolecular dispersion agents in place of acid used, for a peptization agent. It is also acceptable to prepare the liquid dispersion of fine particles by dispersing and peptizing inorganic fine particles in water with the use of at least one organic acid and cationic polymer.

The solvent for a liquid dispersion of fine particles is not particularly limited as long as it is an aqueous medium such as water and a mixture solution of water and an organic solvent miscible with water. The organic solvent miscible with water includes, for instance, an alcohol such as methanol, ethanol and propanol; a lower alkyl ether of a polyhydric alcohol such as ethyleneglycolmonomethyl ether and ethyleneglycoldimethyl ether; a ketone such as acetone and methylethylketone; and an ether such as tetrahydrofuran.

An ink-receiving layer according to the present invention is formed by using a water-soluble resin and/or water-dispersible resin as well as the above described inorganic fine particles. The water-soluble resin or the water-dispersible resin to be used in the present invention includes, for instance, gelatine, casein and a modified compound thereof; a cellulose derivative such as methylcellulose, carboxymethylcellulose and hydroxyethylcellulose; completely or partially saponificated polyvinyl alcohol or a modified compound thereof (cation-modified, anion-modified, silanol-modified compounds and the like); an urea resin; a melamine resin; an epoxy resin; an epichlorohydrin resin; a polyurethane resin; a polyethyleneimine resin; a polyamide resin; a polyvinylpyrrolidone resin; a polyvinylbutyral resin; poly(meth)acrylic acid or a copolymer thereof; an acrylamide resin; a maleic anhydride copolymer; a polyester resin; an SBR latex; an NBR latex; a methylmethacrylate-butadiene copolymer latex; an acrylic polymer latex such as an acrylate copolymer; a vinyl polymer latex such as ethylene-vinyl acetate copolymer; and a functional-group-modified polymer latex obtained by imparting a cationic group or an anionic group to any of the above various polymer latexes. A preferred water-soluble resin or water-dispersible resin is a polyvinyl alcohol which is obtained by hydrolyzing polyvinyl acetate and has an average polymerization degree of 300 to 5,000. The polyvinyl alcohol has a saponification degree of preferably 70% or more but less than 100%, and particularly preferably of 80 to 99.5%. The above described water-soluble resins or water-dispersible resins can be used singly, or a plurality of them may be mixed and used.

The mixture mass ratio of the above described inorganic fine particles (A) to the water-soluble resin and/or the water-dispersible resin (B) is preferably A:B=1:1 to 30:1, and further preferably is in a range of A:B=1.5:1 to 20:1. When the mixture mass ratio of the above described inorganic fine particles (A) to the water-soluble resin and/or water-dispersible resin (B) is in this range, a formed ink-receiving layer hardly causes cracking and a powdery coming-off and has adequate ink absorbency. A method of mixing the above described inorganic fine particles with the water-soluble resin and/or water-dispersible resin is not limited in particular, but is preferably a method of previously dissolving the water-soluble resin and/or water-dispersible resin in a necessary amount of an aqueous medium and mixing it with a liquid dispersion of fine particles. They can be mixed in any method of a batch system and a continuous system.

For the recording medium according to the present invention, the ink-receiving layer may contain a hardening agent, in order to improve a film-forming capability, water resistance and film strength of a film formed with inorganic fine particles and a water-soluble resin and/or a water-dispersible resin. The hardening agent can be selected from various hardening agents generally according to the type of a reactive group in a polymer to be used. For instance, when an ink-receiving layer employs a polyvinyl alcohol resin, the usable hardening agent includes an epoxy hardening agent or an inorganic hardening agent such as a boron compound like boric acid and a water-soluble aluminum salt.

The amount of a hardening agent to be used in an ink-receiving layer varies depending on the amount of a water-soluble resin and/or a water-dispersible resin to be used as a binder, but generally is 0.1 to 30.0 mass % with respect to the amount of the water-soluble resin and/or the water-dispersible resin. When the content of a hardening agent is less than 0.1 mass % with respect to the content of the water-soluble resin and/or the water-dispersible resin, the ink-receiving layer has decreased the film-forming capability and does not provide sufficient water resistance. On the contrary, when the content of a hardening agent exceeds 30.0 mass %, the viscosity of a coating slip greatly changes with time and the coating stability of the coating slip may be lowered.

For the recording medium according to the present invention, an ink-receiving layer may contain a cationic polymer in such a range as not to affect the ink absorbency, in order to effectively prevent an image from bleeding under high-temperature and high-humidity environment. The cationic polymer can be a conventionally well-known polymer, and includes, for instance, a resin of polyallylamine, polyamine sulfone, polyvinylamine, polyethyleneimine, and polyamide epichlorohydrin; a cation-modified compound of polyvinylpyridinium halide, polydimethyldiallyl ammonium chloride and polyacrylamide; and a copolymer of acrylic amide and a cationic monomer, a copolymer of a vinylpyrrolidone monomer and a different general monomer, a copolymer of a vinyloxazolidinone monomer and a different general monomer, and a copolymer of a vinylimidazole monomer and a different general monomer. They can be used singly or in combination of two or more of them.

The solid concentration of a coating slip for forming an ink-receiving layer is not limited in particular as long as the coating slip has a viscosity capable of forming the ink-receiving layer on a substrate, but preferably is 5.0 to 50.0 mass % with respect to the total mass of the coating slip. When the solid concentration is less than 5.0 mass %, it is necessary to increase a coating amount for thickening the film thickness of the ink-receiving layer, which requires much time and energy for drying and accordingly is noneconomic. When the solid concentration exceeds 50.0 mass %, the viscosity of the coating slip increases and may degrade the applicability.

The above described coating slip can contain various additives in such a range as not to hinder the composition from showing an effect of the present invention. Such an additive includes an antifoamer, an ink fixer, a dot moderator, a coloring agent, a fluorescent whitening agent, an antiseptic agent, a pH regulator, a penetrant, an antistatic agent, a conductive agent, an ultraviolet-absorbing agent and an antioxidant (a color-fading inhibitor).

A prepared coating slip can be applied on a substrate with a conventionally well-known coating method such as a roll coating method, a blade coating method, an air-knife coating method, a gate-roll coating method, a bar coating method, a size pressing method, a spin coating method, a spray coating method, a gravure coating method, a curtain coater method and a die coating method. An ink-receiving layer can be formed by subsequently drying the coated slip with the use of a drying device such as a hot air dryer, a heat drum and a far infrared ray dryer. The ink-receiving layer of a recording medium according to the present invention may be formed into a multilayer by changing the composition ratio among inorganic fine particles, a binder and other additives in each layer. It can be also formed on both surfaces of the substrate as well as on one surface. The ink-receiving layer may be smoothed with the use of an apparatus such as a calendar and a cast, for the purpose of improving the resolution of an image and transportability.

The amount of a coating slip to be applied onto a substrate is preferably in a range of 0.5 to 60.0 g/m² in terms of solid content, and more preferably is in a range of 5.0 to 55.0 g/m². When the applied amount is less than 0.5 g/m², ink may flow around or a formed image may bleed because a formed ink-receiving layer cannot sufficiently absorb the water of the ink. When the applied amount exceeds 60.0 g/m², a formed recording medium may cause curling when dried and may not provide so excellent printing performance as has been expected.

The reason why a recording medium with the use of a substrate according to the present invention as described above can inhibit an image from bleeding out under high-temperature and high-humidity environment is not clear, but is considered to be caused by the following phenomenon. In the case of the recording medium using a non-absorptive substrate such as resin-coated paper, the bleeding is considered to occur since a high boiling solvent contained in ink diffuses together with a dye into a receiving layer. On the other hand, in the case of the recording medium according to the present invention, it is presumed that a dye in the ink is adsorbed by alumina particles in the ink-receiving layer, the organic solvent permeates into the resin layer, thus the coloring material and the organic solvent are separated, and accordingly the solvent and the dye do not diffuse together with each other.

Ink to be used for recording an image on a recording medium according to the present invention is not limited in particular, but is preferably an aqueous ink used for general ink jet recording, which employs a mixture of water and a water-soluble organic solvent as a medium and contains a dye or pigment of a coloring material dissolved or dispersed in the mixture.

A particularly suitable method for applying the above described ink to the above described recording medium to form an image is an ink jet recording method. Any method can be employed as the ink jet recording method as long as it effectively releases the ink from a nozzle and applies the ink to the recording medium. A particularly effectively usable method is an ink jet system which rapidly changes an ink volume by applying thermal energy to the ink and ejects the ink from a nozzle by using an acting force generated by the volume change, and which is described in Japanese Patent Application Laid-Open No. S54-59936.

### EXAMPLES

Next, the present invention will be more specifically described with reference to Examples. In the following examples, “part” and “%” are based on mass unless otherwise described.

<Production of Substrate (A)>

A substrate (A) was produced by the steps of preparing a woodfree paper (with a thickness of 145 μm, basis weight of 147.8 g/m² and smoothness of 153 seconds) as a base material and a cellophane film as a material for a resin layer (with thickness of 21 μm, basis weight of 29.5 g/m², contact angle of 22.3° and water vapor transmission rate of 710 g/m²/24 hr); applying a mixture product of adhesives (mixture of trade name TAKELAC A-520 and trade name TAKENATE A-50 (made by Mitsui Takeda Chemicals, Inc.) with a mixture ratio of A-520/A-50=4/1 and solid concentration of 25% after having been mixed and diluted) onto the above described cellophane film so as to have a dry coating weight of 6 g/m² with the use of a gravure coater; drying it; and then laminating it on the woodfree paper. The obtained substrate was subjected to the test of the following evaluation 1.

<Production of Substrate (B)>

A substrate (B) was produced by the same method as the method for producing the substrate (A) except that a coat paper (with a thickness of 178 μm, basis weight of 160.4 g/m² and smoothness of 230 seconds) was used instead as a base material in the method for producing the substrate (A); and was subjected to the test of the following evaluation 1.

<Production of Substrate (C)>

A substrate (C) was produced by the same method as the method for producing the substrate (A) except that a polyvinyl alcohol film (with a thickness of 30 μm, contact angle of 28.5° and water vapor transmission rate of 370 g/m²/24 hr) was used instead as a material for a resin layer in the method for producing the substrate (A); and was subjected to the test of the following evaluation 1.

<Production of Substrate (D)>

A substrate (D) was produced by the same method as the method for producing the substrate (B) except that a polyvinyl alcohol film (with a thickness of 30 μm, contact angle of 28.5° and water vapor transmission rate of 370 g/m²/24 hr) was used instead as a material for a resin layer in the method for producing the substrate (B); and was subjected to the test of the following evaluation 1.

<Production of Substrate (E)>

A substrate (E) was produced by the same method as the method for producing the substrate (A) except that a polyvinyl alcohol film (with a thickness of 65 μm, contact angle of 32.3° and water vapor transmission rate of 100 g/m²/24 hr) was instead used as a material for a resin layer in the method for producing the substrate (A); and was subjected to the test of the following evaluation 1.

<Production of Substrate (F)>

A substrate (F) was produced with reference to a conventionally well-known method for producing a cellulose casing by the steps of applying viscose onto a woodfree paper (with a thickness of 145 μm, basis weight of 147.8 g/m² and smoothness of 153 seconds); and converting it into a regenerated cellulose film with a thickness of 30 μm. The surface of the cellulose film had a contact angle of 23.5° and a water vapor transmission rate of 590 g/m²/24 hr (the water vapor transmission rate of the cellulose film is a value obtained by subtracting the water vapor transmission rate of a base material from the water vapor transmission rate of the substrate (F)). The obtained substrate was subjected to the test of the following evaluation 1.

<Substrate (G)>

A substrate (G) was produced by using a polyethylene-coated paper (having a polyethylene-coated layer with a thickness of 30 μm, contact angle of 96.8°, water vapor transmission rate of 15 g/m²/24 hr and 60-degree specular glossiness of 64% according to JIS-Z-8741); and was subjected to the test of the following evaluation 1.

<Evaluation 1: Evaluation Method for Ink Absorbency of Substrate>

Ink absorbency was evaluated by the steps of conducting solid printing with a black ink (with a shot-in quantity of ink of 100%) on the surface of a resin layer of a substrate with the use of an inkjet printer (BJ F870, trade name, made by Canon Inc.); leaving the substrate at 23° C. and 50% RH for 24 hours; and confirming a dried state by touching the printed part with a finger. When the ink was not transferred onto the finger, the substrate was evaluated to be “A”, when a small amount of a dye was transferred onto the finger, the substrate was evaluated to be “B”, and when the ink was not completely dried and was transferred onto the finger, the substrate was evaluated to be “C”. The result is shown in Table 1.

TABLE 1

| | | resin layer | | | | |
|---|---|---|---|---|---|---|
| | | | | water vapor | | |
| | | | contact | transmission | | evaluation 1 |
| | base | | angle | rate | thickness | ink |
| substrate | material | material | (°) | (g/m²/24 hr) | (μm) | absorbency |
| A | woodfree | cellophane | 22.3 | 710 | 21 | A |
| | paper | (cellulose) | | | | |
| B | coat | cellophane | 22.3 | 710 | 21 | A |
| | paper | (cellulose) | | | | |
| C | woodfree | polyvinyl | 28.5 | 370 | 30 | A |
| | paper | alcohol | | | | |
| D | coat | polyvinyl | 28.5 | 370 | 30 | A |
| | paper | alcohol | | | | |
| E | woodfree | polyvinyl | 32.3 | 100 | 65 | B |
| | paper | alcohol | | | | |
| F | woodfree | cellulose | 23.5 | 590 | 30 | A |
| | paper | | | | | |
| G | woodfree | polyethylene | 96.8 | 15 | 30 | C |
| | paper | | | | | |

<Production of Alumina Hydrate and Liquid Dispersion>

Aluminum dodecanoxide was produced with a method described in U.S. Pat. No. 4,242,271. Subsequently, this aluminum dodecanoxide was hydrolyzed to produce an alumina slurry with the method described in U.S. Pat. No. 4,202,870. Water was added to the alumina slurry till the alumina hydrate solid content reached 7.7%. At this time, the pH of the alumina slurry was 9.4. The pH was adjusted by adding a nitric acid solution of 3.9%. A colloidal sol was obtained by subsequently aging the slurry in an autoclave in conditions of a pH of 6.0, an aging temperature of 150° C. and an aging period time of six hours. The colloidal sol was spray-dried at an inlet temperature of 87° C. to obtain alumina hydrate powder.

An alumina liquid dispersion with a solid concentration of 20% was further prepared by adding 27.3 parts of the thus obtained alumina hydrate, 9.10 parts of a 6% aqueous acetic acid solution (2% with respect to alumina hydrate) to 100 parts of ion-exchange water, and stirring it at 350 rpm for 10 minutes with the use of a three-one motor (trade name: BL600 made by Shinto Scientific Co.). In addition, the thus obtained alumina liquid dispersion was dried at 60° C., and was disintegrated into powder. As a result of having analyzed the crystal structure of the powder with the use of an X-ray diffractometer (X'Pert-PRO made by PANalytical Corporation), the powder showed a boehmite structure. Furthermore, after having vacuum-deaired the above described powder at 120° C. for 24 hours, the BET specific surface area was measured with the use of a specific surface area/pore distribution measuring instrument (trade name: TriSter3000, made by Micromeritics Corporation (Shimadzu Corporation), adsorption gas: nitrogen), and was found to be 139.7 m²/g.

### Example 1

A coating slip was prepared by the steps of adding 0.4 parts of boric acid (20% with respect to polyvinyl alcohol) into 100 parts of the previously-prepared alumina liquid dispersion; further adding 20 parts of a 10% aqueous solution of polyvinyl alcohol (PVA224 made by Kuraray Co.) (10% with respect to alumina hydrate); and stirring it with a three-one motor until becoming a homogeneous state. A recording medium according to the present invention was prepared by applying the thus prepared coating slip onto a substrate (A) with a Mayer bar so as to have a dry coating amount of 35 g/m² followed by drying with a blast constant temperature dryer (trade name: FC-610, made by Toyo Engineering Works Co.) at 110° C. for 20 minutes. The obtained recording medium was subjected to the following evaluations 2 to 5.

Various properties of the thus obtained recording medium were evaluated in the following procedure.

<Evaluation 2: Evaluation Method for Glossiness>

With the use of a glossmeter (trade name: VG-2000, made by Nippon Denshoku Industries Co.), the 20-degree specular glossiness and 75-degree specular glossiness were measured for the surface of the ink-receiving layer of a recording medium according to JIS-Z-8741. The obtained values are shown in Table 2.

<Evaluation 3: Evaluation Method for Printing Density>

Printing density was evaluated by conducting solid printing of a single color with a black (Bk) ink, cyan (C) ink, magenta (M) ink and yellow (Y) ink on the above prepared recording medium with the use of an inkjet printer (trade name: BJ F870, made by Canon Inc.) with a shot-in amount of ink of 100%; and measuring the optical density of each solid-printed color with the use of an optical reflectance densitometer (RD-918 made by Gretag Macbeth Corporation) The obtained values are shown in Table 2.

<Evaluation 4: Evaluation Method for Ink Absorbency>

Ink absorbency was evaluated by conducting solid printing of a green color (ink mixing ratio of cyan/photo-cyan/yellow of 85/90/100) on a recording medium in a shot-in ink amount range of 90 to 270% with the use of an inkjet printer (trade name: BJ F870, made by Canon Inc.); and determining the maximum shot-in amount which did not cause beading. A recording medium which showed a maximum shot-in amount of ink of 200% or more was evaluated as “A”; a recording medium which showed a maximum shot-in amount of ink of 170% or more but less than 200% was evaluated as “B”; and a recording medium which showed a maximum shot-in amount of ink of less than 170% was evaluated as “C”. The result is shown in Table 2.

<Evaluation 5: Evaluation Method for Image Bleeding Under High-Temperature and High-Humidity Environment>

Image bleeding was evaluated by conducting solid printing of a black color (ink mixing ratio of cyan/magenta/yellow of 50/50/50, and with shot-in amount of ink of 150%) on a recording medium with the use of an inkjet printer (trade name of BJ F870 made by Canon Inc.); and exposing it to an environment of 30° C. and 80% RH for one week; and evaluating the degree of bleeding of an image by visual inspection. A recording medium which did not cause bleeding was evaluated as “A”; a recording medium which slightly caused bleeding was evaluated as “B”; and a recording medium which greatly caused bleeding was evaluated as “C”. The result is shown in Table 2.

### Examples 2 to 6>

Recording media were prepared by the same method as in Example 1 except that the substrate (A) was changed to substrates (B) to (F) in Example 1; and was subjected to the tests of the evaluation 2 to 5. The result is shown in Table 2.

### Comparative Example 1

A recording medium was prepared by the same method as in Example 1 except that the substrate (A) was changed to a woodfree paper (with a thickness of 145 μm, basis weight of 147.8 g/m² and smoothness of 153 seconds) in Example 1; and was subjected to the tests of the evaluation 2 to 5. The result is shown in Table 2.

### Comparative Example 2

A recording medium was prepared by the same method as in Example 1 except that the substrate (A) was changed to a woodfree paper (with a thickness of 178 μm, basis weight of 160.4 g/m² and smoothness of 230 seconds) in Example 1; and was subjected to the tests of the evaluation 2 to 5. The result is shown in Table 2.

### Comparative Example 3

A recording medium was prepared by the same method as in Example 1 except that the substrate (A) was changed to the substrate (G) and the coating slip was applied on the polyethylene-coated layer of which the surface had been treated with corona discharge; and was subjected to the tests of the evaluation 2 to 5. The result is shown in Table 2.

### Comparative Example 4

A recording medium was prepared by the same method as in Example 1 except that 0.667 parts of a cationic polymer (trade name: PAS-A-120L, 30% aqueous solution, weight average molecular weight: about 100,000, produced by Nitto Boseki Co.) (1% with respect to alumina hydrate) was added into the coating slip, and further the substrate (A) was changed to the substrate (G) of which the surface of a polyethylene-coated layer had been treated with corona discharge; and was subjected to the tests of the evaluation 2 to 5. The result is shown in Table 2.

TABLE 2

| | | | | | | | | | Evaluation 5 |
|---|---|---|---|---|---|---|---|---|---|
| | | | | | | | | | image |
| | | | | | | | | | bleeding |
| | | | | | | | | Evaluation 4 | under high- |
| | | | | | | | | ink | temperature |
| | | Evaluation 2 | | Evaluation 3 | | | | absorbency | and high- |
| | | glossiness | | printing density | | | | shot-in | humidity |
| | substrate | 20° | 75° | Bk | C | M | Y | amount | environment |
| Example 1 | A | 21.4 | 63.0 | 2.24 | 2.63 | 2.32 | 2.25 | A | A |
| Example 2 | B | 21.8 | 61.7 | 2.29 | 2.63 | 2.34 | 2.30 | A | A |
| Example 3 | C | 21.5 | 62.5 | 2.27 | 2.56 | 2.28 | 2.23 | A | A |
| Example 4 | D | 22.0 | 63.2 | 2.24 | 2.58 | 2.30 | 2.24 | A | A |
| Example 5 | E | 23.1 | 63.5 | 2.32 | 2.61 | 2.31 | 2.27 | A | B |
| Example 6 | F | 13.2 | 53.5 | 2.18 | 2.52 | 2.27 | 2.15 | A | A |
| Comparative | woodfree | 3.1 | 38.2 | 2.25 | 2.59 | 2.32 | 2.30 | A | A |
| Example 1 | paper | | | | | | | | |
| Comparative | coat | 3.5 | 43.5 | 2.15 | 2.45 | 2.21 | 2.11 | A | A |
| Example 2 | paper | | | | | | | | |
| Comparative | G | 19.2 | 58.7 | 2.17 | 2.50 | 2.20 | 2.12 | B | C |
| Example 3 | | | | | | | | | |
| Comparative | G | 19.3 | 59.2 | 2.08 | 2.44 | 2.10 | 1.91 | B | C |
| Example 4 | | | | | | | | | |

As is clear from Table 2, the recording medium produced with the use of the substrate according to the present invention showed high glossiness and high printing density, and enabled recording of a high-quality image. The substrate according to the present invention also showed excellent ink absorbency and an effect of preventing the image from bleeding under high-temperature and high-humidity environment, in comparison with polyethylene-coated paper.

With the present invention, an ink-receiving layer superior in glossiness can be formed without smoothing treatment, by using a substrate comprising a base material and a resin layer with ink absorbency and/or ink permeability provided on the base material, and further a recording medium which has excellent image density and ink absorbency can be provided, which effectively prevents an image from bleeding under high-temperature and high-humidity environment.

While the invention has been described with reference to the preferred embodiments disclosed herein, it is not confined to the details set forth and this application is intended to cover such modifications or changes as may come within the purpose of the improvements or the scope of the appended claims.

This application claims priority benefits of Japanese Patent Applications No. 2005-216533 filed Jul. 26, 2005 and No. 2006-167645 filed Jun. 16, 2006 the entire disclosures of which are incorporated herein by reference in their entirety.

What is claimed is:

1. A recording medium having an ink-receiving layer provided on at least one surface of a substrate, wherein the substrate comprises a base material, and a resin layer having ink absorbency and/or ink permeability formed at least on the side of the base material on which the ink-receiving layer is provided, and wherein the resin layer has such a contact angle with respect to water, a water vapor transmission rate according to JIS-Z-0208 and a thickness as to satisfy the following relationships (1) to (3):
contact angle of resin layer≦60° (1)
water vapor transmission rate of resin layer≧100 g/m²/24 hr (2)
10 μm≦thickness of resin layer≦100 μm (3).

2. The recording medium according to claim 1, wherein the resin layer includes as a major component at least one resin selected from the group consisting of cellulose and a derivative thereof; a vinyl polymer such as polyvinyl alcohol and ethylene-vinyl alcohol copolymer; an acrylic polymer such as polyacrylonitrile and (meth)acrylates; and a polysulfone polymer.

3. The recording medium according to claim 1, wherein the ink-receiving layer includes inorganic fine particles, and a water-soluble resin and/or water-dispersible resin.
